(19) United States
(12) Patent Application Publication
(10) Pub. No.: US 2022/0281308 A1
(43) Pub. Date: Sep. 8, 2022

(54) TRANSFER CASE

(71) Applicant: BorgWarner Inc., Auburn Hills, MI (US)

(72) Inventors: Chengyun Guo, Novi, MI (US); Keith Van Maanen, Bloomfield Hills, MI (US)

(21) Appl. No.: 17/192,960

(22) Filed: Mar. 5, 2021

(51) Int. Cl. B60K 6/44; B60K 6/383; B60K 6/365; B60K 6/387; B60K 6/405; B60K 6/52

(52) U.S. Cl. CPC B60K 6/44; B60K 6/383; B60K 6/365; B60K 6/387; B60K 6/405; B60K 6/52; B60Y 2200/92; B60Y 2400/428; B60Y 2400/427; B60Y 2400/73; B60Y 2400/82

(57) ABSTRACT

A transfer case for use in a vehicle, with the vehicle including a powertrain, includes an input shaft configured to be rotatably coupled to the powertrain. The transfer case also includes a primary output shaft rotatably coupled to the input shaft, and a secondary output shaft selectively rotatably coupled to the primary output shaft. The transfer case further includes a planetary gearset disposed between and rotatably coupled to the input shaft and the primary output shaft. The transfer case also includes an input member and an electric machine. The input member is rotatably coupled to the electric machine and the input shaft to provide rotational torque from the electric machine, to the input shaft, and to the primary output shaft.

### BACKGROUND OF THE INVENTION

### 1. Field of the Invention

The present invention generally relates to a transfer case for use in a vehicle.

### 2. Description of the Related Art

Conventional transfer cases in the art typically include an input shaft coupled to an engine and a transmission of a vehicle, a primary output shaft for delivering rotational torque to rear wheels of the vehicle, and a secondary output shaft for delivering rotational torque to front wheels of the vehicle. Vehicles including a conventional transfer case are able to switch the vehicle between a rear wheel drive only mode, and a four-wheel or all-wheel drive mode through use of the transfer case.

In recent years, there has been a desire for vehicles to have improved fuel economy and performance. In such vehicles, electric motors have been added to assist in propelling the vehicle. Such vehicles are typically referred to as hybrid vehicles. Hybrid vehicles (or hybrid powertrains) typically include two different drive sources that cooperatively provide drive torque for moving the vehicle. For example, the two different drive sources can be a powertrain, such as an internal combustion engine, and an electric motor. In such an example, the hybrid vehicle or hybrid powertrain can operate in various modes with drive torque being provided by the internal combustion engine alone, by the electric motor alone, or by both the internal combustion engine and the electric motor. However, past hybrid vehicles and hybrid powertrains utilize specialized powertrains that are considerably different from existing traditional powertrains, thereby requiring extensive and costly design changes. In particular, hybrid vehicles having rear-wheel and four-wheel/all-wheel drive utilize the electric motor and the powertrain in combination with the transfer case, which also requires extensive and costly design changes.

As such, there remains a need to provide an improved transfer case including an electric motor.

### SUMMARY AND ADVANTAGES

A transfer case for use in a vehicle, with the vehicle including a powertrain for providing rotational torque to at least one of a first and second set of wheels of the vehicle, includes an input shaft configured to be rotatably coupled to the powertrain. The transfer case also includes a primary output shaft rotatably coupled to the input shaft to provide rotational torque to the first set of wheels of the vehicle, and a secondary output shaft selectively rotatably coupled to the primary output shaft to provide rotational torque to the second set of wheels of the vehicle. The transfer case further includes a planetary gearset disposed between and rotatably coupled to the input shaft and the primary output shaft. The transfer case also includes an input member and an electric machine. The input member is rotatably coupled to the electric machine and the input shaft to provide rotational torque from the electric machine, to the input shaft, and to the primary output shaft.

Accordingly, having the input member rotatably coupled to the electric machine and the input shaft to provide rotational torque from the electric machine, to the input shaft, and to the primary output shaft results in a reduction of the packaging size and improved packaging of the transfer case. Additionally, having the input member rotatably coupled to the electric machine and the input shaft to provide rotational torque from the electric machine, to the input shaft, and to the primary output shaft allows an electric machine to be added to a traditional transfer case with minimal redesign of the traditional transfer case.

In another embodiment, a transfer case for use in a vehicle, with the vehicle including a powertrain for providing rotational torque to at least one of a first and second set of wheels of the vehicle, includes an input shaft configured to be rotatably coupled to the powertrain. The transfer case also includes a primary output shaft rotatably coupled to the input shaft to provide rotational torque to the first set of wheels of the vehicle, and a secondary output shaft selectively rotatably coupled to the primary output shaft to provide rotational torque to the second set of wheels of the vehicle. The transfer case further includes a planetary gearset disposed between and rotatably coupled to the input shaft and the primary output shaft. The transfer case additionally includes an input member configured to provide rotational torque to the primary output shaft, and an electric machine rotatably coupled to the input member. The transfer case also includes a clutch rotatably coupled to the input shaft, the planetary gearset, and the primary output shaft. The clutch is further defined as a dual clutch.

Having the clutch of the transfer case rotatably coupled to the input shaft, the planetary gearset, and the primary output shaft, and having the clutch further defined as a dual-clutch, allows the transfer case to utilize two gear ratios when in an electric only drive mode, which increases performance and drive capabilities of the vehicle when using the electric machine to propel the vehicle.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic view of a transfer case including an input shaft, a primary output shaft, a secondary output shaft, a planetary gearset, an electric machine, and an input member, with the input member being rotatably coupled to the electric machine and the input shaft;

FIG. 2 is a schematic view the transfer case, with the transfer case including a disconnect clutch coupled to the input shaft and the input member for selectively rotatably coupling the electric machine to the input shaft;

FIG. 3 is a schematic view of the transfer case, with the transfer case including a second planetary gearset rotatably coupled to said electric machine and said input member;

FIG. 4 is a schematic view of the transfer case, with the transfer case including a clutch rotatably coupled to the input shaft, the planetary gearset, and the primary output shaft, and with the clutch being further defined as a dual clutch;

FIG. 5 is a schematic view of the transfer case, with the clutch being further defined as a selectable one-way clutch and a wet clutch;

FIG. 6 is a schematic view of the transfer case and another embodiment of the clutch;

FIG. 7 is a schematic view of a vehicle including the transfer case.

### DETAILED DESCRIPTION OF THE INVENTION

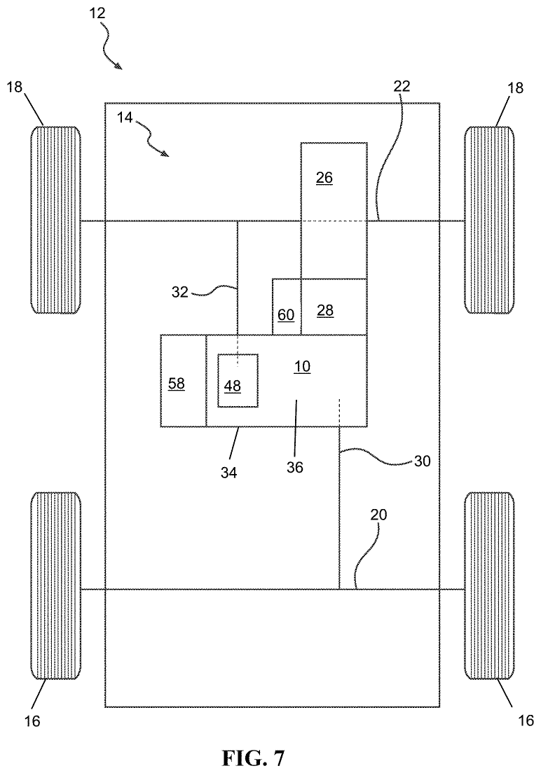

With reference to the Figures, wherein like numerals indicate like parts throughout the several views, a schematic view of a transfer case 10 for use in a vehicle 12 is shown in FIG. 7. The vehicle 12 includes a powertrain 14 for providing rotational torque to at least one of a first and second set of wheels 16, 18 of the vehicle 12. The vehicle 12 may be an all-wheel drive or four-wheel drive vehicle. The transfer case 10 transfers rotational torque from a transmission 28 of the vehicle 12 to a rear axle 20 of the vehicle 12 and/or a front axle 22 of the vehicle. The first set of wheels 16 are rotatably coupled to one of the front axle 22 and rear axle 20 of the vehicle 12 and the second set of wheels 18 are rotatably coupled to the other of the front axle 22 and rear axle 20 of the vehicle 12. In one embodiment, the vehicle 12 has four wheels, with two wheels rotatably coupled to the front axle 22 and two wheels rotatably coupled to the rear axle 20.

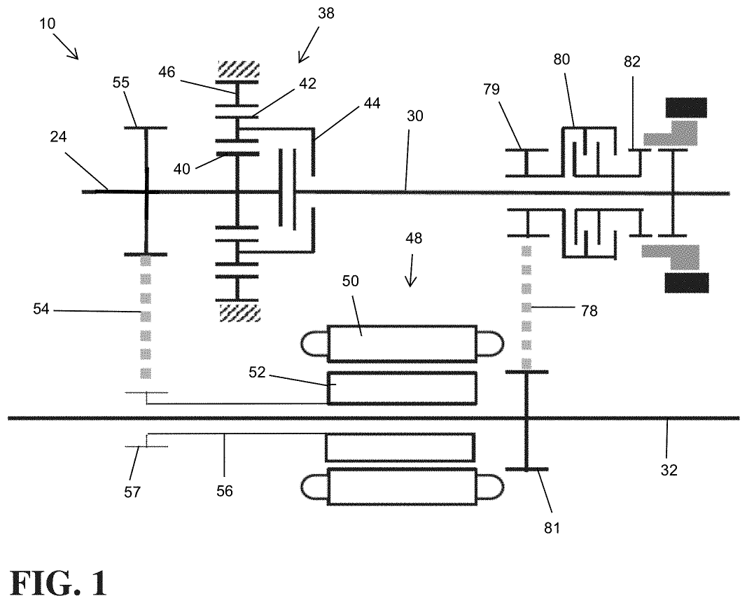

With reference to FIG. 1, the transfer case 10 includes an input shaft 24 configured to be rotatably coupled to the powertrain 14. With reference again to FIG. 7, the powertrain 14 propels the vehicle 12 by providing rotational torque to at least one of the first and second set of wheels 16, 18. The powertrain 14 may include an engine 26 (such as an internal combustion engine) and the transmission 28. In such embodiments, the powertrain 14 functions as an external drive source to the transfer case 10 by providing rotational torque from the engine 26, to the transmission 28, and to the transfer case 10 to then provide rotational torque to at least one of the first and second set of wheels 16, 18 of the vehicle 12.

With reference again to FIG. 1, the transfer case 10 also includes a primary output shaft 30 rotatably coupled to the input shaft 24 to provide rotational torque to the first set of wheels 16 of the vehicle 12, and a secondary output shaft 32 selectively rotatably coupled to the primary output shaft 30 to provide rotational torque to the second set of wheels 18 of the vehicle 12. Although not required, the primary and secondary output shafts 30, 32 are typically parallel to one another.

The transfer case 10 may include a housing 34 defining a housing interior 36. The primary and secondary output shafts 30, 32 may be supported by the housing 34 and radial bearings (not shown).

In some embodiments, the primary output shaft 30 selectively provides rotational torque to the rear axle 20 of the vehicle 12 and the secondary output shaft 32 selectively provides rotational torque to the front axle 22 of the vehicle 12. In such embodiments, the primary output shaft 30 may be further defined as a rear-wheel output shaft, with the first set of wheels 16 of the vehicle 12 being rear wheels, and the secondary output shaft 32 may be further defined as a front-wheel output shaft, with the second set of wheels 18 of the vehicle 12 being front wheels. In other embodiments, the primary output shaft 30 may be further defined as a front-wheel output shaft, with the first set of wheels 16 of the vehicle 12 being front wheels, and the secondary output shaft 32 may be further defined as a rear-wheel output shaft, with the second set of wheels of the vehicle 12 being rear wheels. In either embodiment, the primary output shaft 30 is the primary torque output of the transfer case 10. In other words, if the vehicle 12 is a rear-wheel drive vehicle, then the primary output shaft 30 is rotatably coupled to the rear axle 20 of the vehicle 12 to provide rotational torque to the rear axle 20. If the vehicle 12 is a front-wheel drive vehicle, then the primary output shaft 30 is rotatably coupled to the front axle 22 of the vehicle 12 to provide rotational torque to the front axle 22. In either embodiment, the secondary output shaft 32 is selectively rotatably coupled to the primary output shaft 30 to provide secondary rotational torque to one of the sets of wheels of the vehicle 12, as described in further detail below.

The transfer case 10 further includes a planetary gearset 38 disposed between and rotatably coupled to the input shaft 24 and the primary output shaft 30. The planetary gearset 38 may be further defined as a range planetary gearset. Typically, the planetary gearset 38 has sun gear 40, planet gears 42, a planet carrier 44, and a ring gear 46. The planet gears 42 are positioned radially between and are engaged with the sun gear 40 and the ring gear 46. The planet carrier 44 is coupled to the planet gears 42 and rotates relative to the sun gear 40 as the planet gears 42 orbit the sun gear 40. The planet carrier 44 is rotatably coupled to the primary output shaft 30 to rotate with the primary output shaft 30 and, therefore, transfer torque therebetween. The planetary gearset 38 essentially functions as a speed coupling device to control power flowing into and out of the transfer case 10, as described in further detail below.

The transfer case 10 also includes an electric machine 48. The electric machine 48 typically includes a stator 50 and a rotor 52 that rotates relative to the stator 50. The stator 50 may be coupled to the housing 34 with the rotor 52 being rotatable with respect to the stator 50 and the housing 34. The electric machine 48 may be coupled to the housing 34 in any suitable manner, and/or may disposed within the housing interior 36. As shown in FIGS. 1-6, the electric machine 48 may be concentric with the secondary output shaft 32. The electric machine 48, in addition to the engine 26, allows the vehicle 12 to utilize two different drive, such as the electric machine 48 and the engine 26. The transfer case 10 including the electric machine 48 is able to be included in the vehicle 12 without significantly altering other components of the vehicle 12. For example, when the transfer case 10 includes the electric machine 48 coupled to the housing 34, the transfer case 10 may be installed in a vehicle including an internal combustion engine to then provide such a vehicle with two power sources for propelling the vehicle. Additionally, the transfer case 10 is able to provide rotational torque from the electric machine 48 to the primary output shaft 30 and the secondary output shaft 32 to selectively provide rotational torque to the first and second set of wheels 16, 18 of the vehicle 12, as described in further detail below.

Due to the location of the transfer case 10, which is between the transmission 28 of the vehicle 12 and an output to the first and/or second set of wheels 16, 18 of the vehicle 12, the electric machine 48 may be commonly referred to as being in a P3 position. The vehicle 12 may be referred to as a hybrid vehicle, a plug-in hybrid vehicle, or a mild hybrid vehicle depending on size of a battery 58 of the vehicle 12.

With reference to FIGS. 1-6, the transfer case 10 further includes an input member 54 rotatably coupled to the input shaft 24, typically through an input sprocket of the transfer case 10, and the electric machine 48 to provide rotational torque from the electric machine 48, to the input shaft 24, and to the primary output shaft 30. Typically, the input member 54 is a chain. However, other suitable input members are contemplated, such as a set of gears. When the input member 54 is rotatably coupled to the input shaft 24 and the electric machine 48, the input member 54 is typically rotatably coupled to an output of the electric machine 56, typically through an electric machine sprocket 57. Additionally, the input member 54 is typically rotatably coupled to the input shaft 24 such that the input member 54 is located at the output of the electric machine 56 and at the input of the planetary gearset 38 through the input shaft 24. The rotor 52 of the electric machine 48 may be rotatably coupled to the input member 54 for providing rotational torque to the input shaft 24.

Having the input member 54 rotatably coupled to the input shaft 24 and the electric machine 48 allows rotational torque from the electric machine 48 to be provided though the input member 54, to the input shaft 24, and, ultimately, to the primary output shaft 30 through the planetary gearset 38. To this end, the electric machine 48 is able to use the planetary gearset 38 to utilize multiple modes of driving. For example, the planetary gearset 38 may allow for two different modes of driving of the transfer case 10 using the electric machine 48. In such instances, a first mode of driving of the transfer case 10 using the electric machine 48 may be a high driving mode (higher rotational speed of the primary output shaft 30), such as a 1:1 ratio from the input shaft 24 to the primary output shaft 30 (i.e., direct coupling between the input shaft 24 and the primary output shaft 30), and a second mode of driving of the transfer case 10 using the electric machine 48 may be a low driving mode (lower rotational speed of the primary output shaft 30) having a ratio different than the high driving mode. By way of non-limiting example, the low driving mode may have any suitable ratio, such as a 1.5:1, 1.96:1, 2.34:1, 2.46:1, 2.61:1, 2.64:1, 2.69:1, 2.72:1, 2.74:1, etc. ratio from the input shaft 24 to the primary output shaft when using the electric machine 48 to propel the vehicle 12. In the low driving mode, the input shaft 24 is typically rotatably coupled to the primary output shaft 30 through the planet gears 42 and the planet carrier 44.

Furthermore, in addition to providing the transfer case 10 with a high and low driving mode, having the input member 54 rotatably coupled to the input shaft 24 removes the need of adding additional components to achieve multiple gear ratios, such as gears, clutches, and/or synchronizers, which ultimately allows the electric machine 48 to be added to the transfer case 10 without significant redesign and increase in size. The high and low driving modes of the transfer case 10 using the electric machine 48 allows the electric machine 48 to propel the vehicle 12 under a variety of driving conditions. Using the low driving mode of the transfer case 10, the electric machine 48 is able to deliver higher torque to the primary output shaft 30 and, optionally, also the secondary output shaft 32. Using the high driving mode of the transfer case 10, the electric machine 48 is able to deliver lower torque but higher rotational speed to the primary output shaft 30 and, optionally, also the secondary output shaft 32. Due to the reduction in gear ratio as a result of the planetary gearset 38 being rotatably coupled to the electric machine 48 through the input member 54 and the input shaft, the planetary gearset 38 allows the electric machine 48 to be a low torque and high speed machine, which allows a smaller footprint (package) than a high torque low speed machine, which requires a larger footprint (package). Additionally, the ratios set forth above (high driving mode and low driving mode) allow a full range of driving applications, which then allows the transfer case 10 to be used in a variety of applications, such as hybrid vehicles, mild hybrid vehicles, and plug-in hybrid electric vehicles.

With reference to FIG. 7, the transfer case 10 may include a battery 58, and a controller 60 for controlling operation of the powertrain 14 and the electric machine 48. The controller 60 controls operation of the transfer case 10. For example, the controller 60 may control current applied to the electric machine 48 based on detected conditions of the vehicle 12, such as dynamic conditions of the vehicle 12 and/or a state of charge of the battery 58. Additionally, the controller 60 may control current applied to the electric machine 48 based on user inputs, such as selecting four-wheel or all-wheel drive.

In addition to transferring torque from the engine 26 to the first and/or second sets of wheels 16, 18, the transfer case 10 as described above is also configured to transfer rotational torque between the electric machine 48 and the rear and/or front axle 20, 22 of the vehicle 12. In such instances, the electric machine 48 functions as an electric motor (i.e., a drive source) to the transfer case 10 to provide rotational torque to the transfer case 10 to provide rotational torque to the rear and/or front axle 20, 22 of the vehicle 12. The electric machine 48 may be powered by the battery 58 to deliver rotational torque to the input member 54 such that the electric machine 48 is configured as an electric motor, and may also charge the battery 58 by recapturing rotational torque from primary output shaft 30 from the rear and/or front axles 20, 22, the input shaft 24, and/or the engine 26 such that the electric machine 48 is configured as a generator.

Typically, the transfer case 10 has four modes of operation. For example, in a first mode of operation, only the powertrain 14 provides rotational torque to at least one of the first and second sets of wheels 16, 18 of the vehicle 12. In a second mode of operation, only the electric machine 48 provides rotational torque to at least one of the first and second sets of wheels 16, 18 of the vehicle 12. In a third mode of operation, both the powertrain 14 and the electric machine 48 provide rotational torque to at least one of the first and second sets of wheels 16, 18 of the vehicle 12. In a fourth mode of operation, the battery 58 is recharged. In the fourth mode of operation, when the vehicle 12 is in motion, at least one of the first and second set of wheels 16, 18 drive the electric machine 48 through at least one of the primary and secondary output shafts 30, 32 and through the input member 54 such that the electric machine 48 functions as a generator to charge the battery 58. In the fourth mode of operation, when the vehicle 12 is stationary, the input shaft 24 drives the electric machine 48 through the input member 54 such that the electric machine 48 functions as a generator to charge the battery 58.

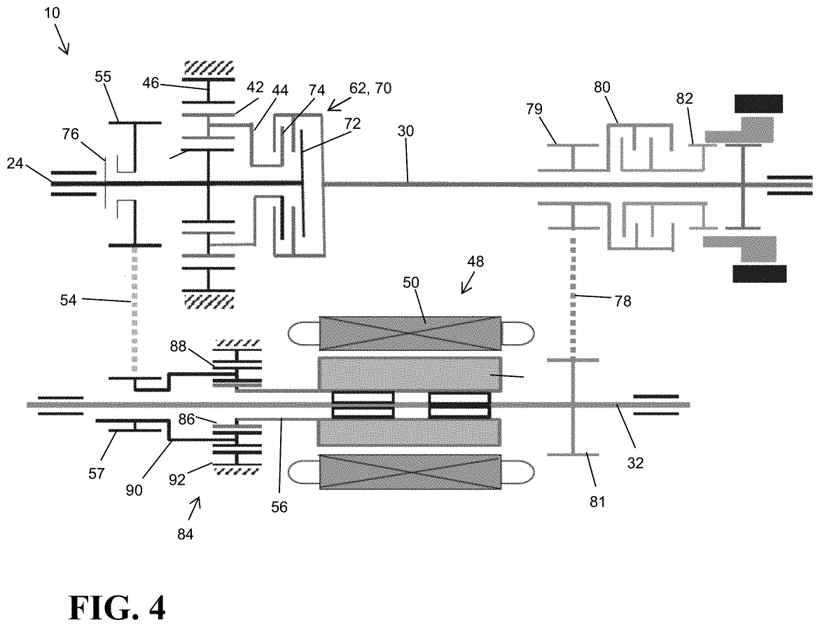

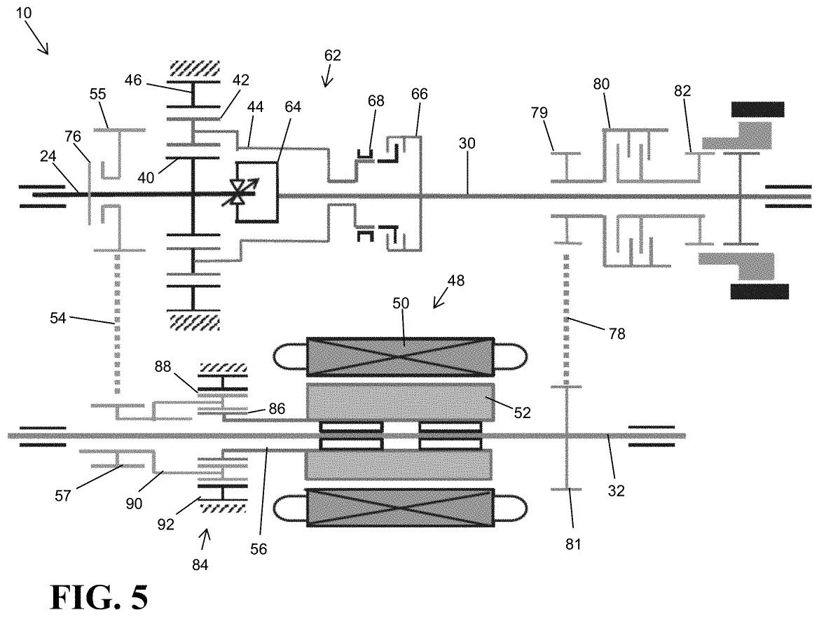

With particular reference to FIGS. 4 and 5, the transfer case 10 may include a clutch 62 rotatably coupled to the planetary gearset 38 and the primary output shaft 30. Typically, the clutch 62 is disposed between the planetary gearset 38 and the primary output shaft 30. Having the clutch 62 rotatably coupled to the planetary gearset 38 and the primary output shaft 30 allows the transfer case 10 to switch between multiple modes of operation. For example, the clutch 62 may rotatably couple the input shaft 24 directly to the primary output shaft 30, which may, for example, result in the above described high driving mode of the transfer case 10. Additionally, the clutch 62 may rotatably couple the input shaft 24 to the primary output shaft 30 through the planetary gearset 38, specifically through the planet carrier 44 of the planetary gearset 38, which may, for example, result in the above described low driving mode of the transfer case 10.

In one embodiment, as shown in FIG. 5, the clutch 62 is further defined as a selectable one-way clutch 64 and a wet clutch 66. In this embodiment, the selectable one-way clutch 64 rotatably couples the input shaft 24 directly to the primary output shaft 30, which may, for example, result in the above described high driving mode of the transfer case 10. The wet clutch 66 rotatably couples the input shaft 24 to the primary output shaft 30 through the planetary gearset 38, specifically through the planet carrier 44 of the planetary gearset 38, which may, for example, result in the above described low driving mode of the transfer case 10. As the transfer case 10 transitions from the high driving mode to the low driving mode, the input shaft 24 overruns the selectable one-way clutch 64 due to the wet clutch 66 facilitating rotational engagement between the planetary gearset 38 and the primary output shaft 30. In this embodiment, the clutch 62 may include a synchronizer 68 to engage and disengage the wet clutch 66. The selectable one-way clutch 64 may be further defined as a multi-mode clutch module. An example of a multi-mode clutch module is disclosed in U.S. Pat. No. 9,726,236, which was filed on Jan. 27, 2014 and issued Aug. 8, 2017, the disclosure of which is incorporated by reference in its entirety.

In one embodiment, the clutch 62 may be a dual clutch 70, as shown in FIG. 4. When the clutch 62 is a dual clutch 70, the transfer case 10 is able to quickly switch between the low and high driving modes. For example, the dual clutch 70 may couple the input shaft 24 to the primary output shaft 30 through a first engagement member 72 of the dual clutch 70 to achieve a high driving mode, and the dual clutch 70 may couple the input shaft to the primary output shaft 30 through planet carrier 44 and a second engagement member 74 of the dual clutch 70 to achieve a low driving mode.

Having the clutch 62 described above rotatably coupled to the planetary gearset 38 and the primary output shaft 30 allows the transfer case 10 to shift between driving modes while the vehicle 12 is in motion. In other words, the vehicle 12 is not required to stop to shift between the low and high driving modes of the transfer case 10. For example, to switch the drive mode between a low and high driving mode, as described above, the clutch 62 goes from directly coupling the input shaft 24 to the primary output shaft 30 to rotatably coupling the planet carrier 44 to the primary output shaft 30.

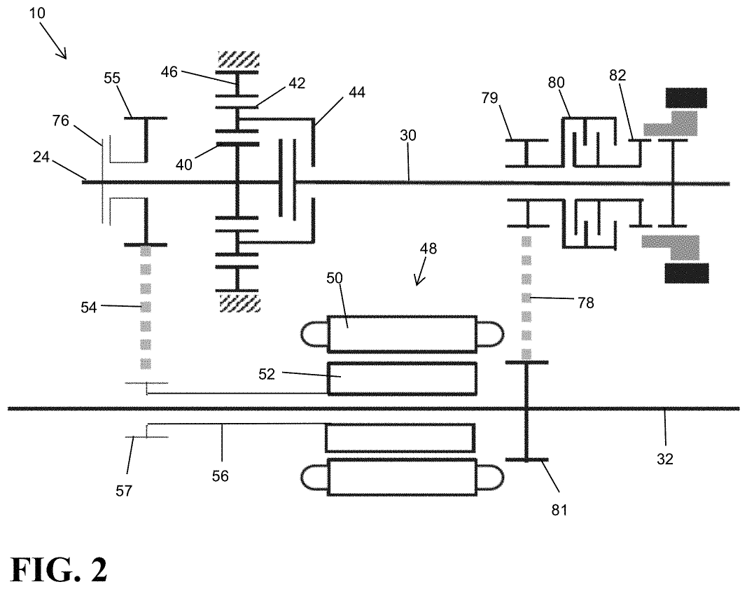

As shown in FIGS. 2-6, the transfer case 10 may include a disconnect clutch 76, such as a dog clutch or a wet clutch, coupled to the input shaft 24 and the input member 54 for selectively rotatably coupling the electric machine 48 to the input shaft 24. When the disconnect clutch 76 couples the electric machine 48 to the input shaft 24, the electric machine 48 is able to provide rotational torque to the input shaft 24 through the input member 54, and the electric machine 48 is able to receive rotational torque from the input shaft 24 through the input member 54 to charge the battery 58 of the vehicle 12. Being able to rotatably couple and decouple the electric machine 48 from the input shaft 24 offers several advantages. First, when the vehicle 12 is in the engine only drive mode, the disconnect clutch 76 may rotatably decouple the electric machine 48 from the input shaft 24, which eliminates the back electromotive force (EFM) loss. Eliminating EFM loss is particularly desired when the electric machine 48 is a permanent magnet electric machine. In addition to eliminating EFM loss, having the disconnect clutch 76 also reduces drag torque due to the electric machine 48 and the input shaft 24 being selectively rotatably decoupled from one another, particularly when the vehicle 12 is moving at higher speeds. In embodiments where the electric machine 48 is an induction electric machine, having the disconnect clutch 76 reduces drag torque due to the electric machine 48 and the input shaft 24 being selectively rotatably decoupled from one another. Second, to deliver both rotational torque from the engine 26 and the electric machine 48, the disconnect clutch 76 rotatably couples the electric machine 48 to the input shaft 24 to deliver rotational torque from the electric machine 48 to the input shaft 24.

The transfer case 10 may include a transfer case input member 78 rotatably coupled to the secondary output shaft 32 and the primary output shaft 30, typically through a primary sprocket 79 rotatably coupled to the primary output shaft 30 and through a secondary sprocket 81 rotatably coupled to the secondary output shaft 32, for rotatably coupling the secondary output shaft 32 and the primary output shaft 30 to provide rotational torque to both the first and second set of wheels 16, 18 of the vehicle 12. Typically, the transfer case input member 78 is a chain.

The transfer case 10 may include a mode clutch 80 coupled to the primary output shaft 30 to selectively rotatably couple the primary output shaft 30 and the secondary output shaft 32 through the transfer case input member 78 to provide rotational torque from the primary output shaft 30, to the transfer case input member 78, and to the secondary output shaft to provide rotational torque to both the first and second set of wheels 16, 18.

Specifically, the mode clutch 80 is used to change the vehicle 12 between a two-wheel drive mode and a four-wheel/all-wheel drive mode. To actuate the mode clutch 80, the transfer case 10 may include a mode clutch actuator 82 to actuate the mode clutch 80 between a mode engaged position where the primary output shaft 30 and the secondary output shaft 32 are rotatably coupled to one another through the transfer case input member 78 to provide rotational torque to both the first and second set of wheels 16, 18, and a mode disengaged position where the primary output shaft 30 and the secondary output shaft 32 are rotatably decoupled from one another such that said input shaft provides rotational torque to only the primary output shaft 30.

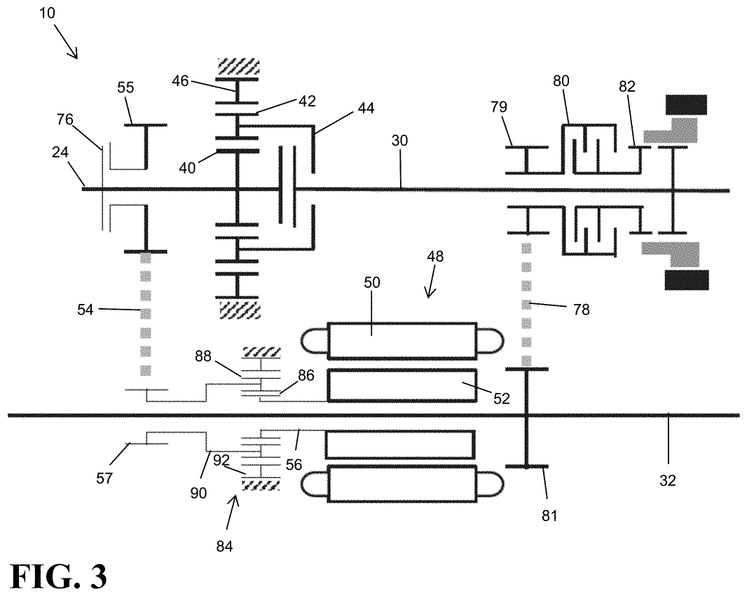

As shown in FIGS. 3-6, the transfer case 10 may include a second planetary gearset 84 rotatably coupled to the electric machine 48 and the input member 54. The second planetary gearset 84 may be further defined as a reduction planetary gearset or an e-motor reduction planetary gearset. Similar to the planetary gearset 38, the second planetary gearset 84 typically includes a second sun gear 86, second planet gears 88, a second planet carrier 90, and a second ring gear 92. The second planet gears 88 are positioned radially between and are engaged with the second sun gear 86 and the second ring gear 92. The second planet carrier 90 is coupled to the second planet gears 88 and rotates relative to the second sun gear 86 as the second planet gears 88 orbit the second sun gear 86. The second planet carrier 90 is rotatably coupled to the electric machine output 56 and the input member 54 to provide rotational torque to the input shaft 24. The second planetary gearset 84 essentially functions as a reduction gear to control power flowing into and out of the transfer case 10. When present, the second planetary gearset 84 allows the electric machine 48 due to the reduction between the electric motor 48 and the input shaft 24.

It is to be appreciated that when the transfer case 10 includes the second planetary gearset 84, the transfer case may include a second clutch rotatably coupling the second planetary gearset 84 to the input member 54. As described above with respect to the clutch 62, the second clutch may be a dual clutch, or a selectable one-way clutch and a wet clutch. Having the second clutch rotatably coupling the second planetary gearset 84 and the input member 54 allows the transfer case 10 to have additional driving modes (gear ratios) in addition to the gear ratios provided by the planetary gearset 38. When the second planetary gearset 84 is present, the electric machine 48 and, specifically, the rotor 52 of the electric machine 48, is rotatably coupled to the input shaft 24 through the second planetary gearset 84 and the input member 54. When the electric machine 48 is providing rotational torque to the input shaft 24 of the transfer case 10, both the second planetary gearset 84 and the input member 54 may provide a reduction in gear ratio when providing rotational torque to the input shaft 24 of the transfer case 10. Due to the reduction in gear ratio as a result of the second planetary gearset 84 being rotatably coupled to the input member 54, the electric machine 48 may be smaller without sacrificing the torque capabilities of the electric drive.

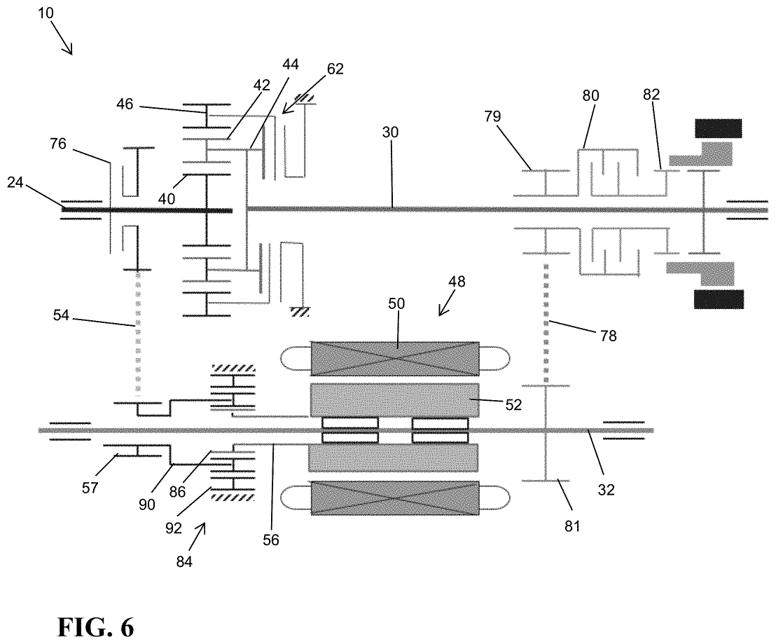

With respect to FIG. 6, another embodiment of the clutch 62 and the planetary gearset 38 is shown. Specifically, in the embodiment of FIG. 6, the clutch 62 includes a first clutch for selectively rotatably coupling the ring gear 46 to the planet carrier 44 to achieve the first mode (i.e., high mode) when the first clutch is closed, and a second clutch for selectively grounding the ring gear 46 to achieve the second mode (i.e., low mode) when the second clutch is closed. When in the first mode, the planetary gearset 38 is locked as a direct drive such that the planetary gearset 38 rotates as a single rigid body. When the first clutch is closed and because the planetary gearset 38 is a direct drive, there is no gear loss or noise from the planetary gearset 38. When in the second mode, the sun gear 40 is rotatably coupled to the planet carrier 44 to provide rotational torque from the planet carrier 44 to the primary output shaft 30. The first clutch may be a wet clutch or a selectable one-way clutch, and the second clutch may be a wet clutch or a selectable one-way clutch. When both the first and second clutches are open, the input shaft 24 is rotatably decoupled from the primary output shaft 30 (i.e., neutral).

In another embodiment, with reference to FIG. 4, the transfer case 10 includes the input shaft 24 configured to be rotatably coupled to the powertrain 14. The transfer case 10 also includes the primary output shaft 30 rotatably coupled to the input shaft 24 to provide rotational torque to the first set of wheels 16 of the vehicle 12, and the secondary output shaft 32 selectively rotatably coupled to the primary output shaft 30 to provide rotational torque to the second set of wheels 18 of the vehicle 12. The transfer case 10 additionally includes the planetary gearset 38 disposed between and rotatably coupled to the input shaft 24 and the primary output shaft 30. The transfer case 10 further includes the input member 54 configured to provide rotational torque to the primary output shaft 30, the electric machine 48 rotatably coupled to the input member 54, and the clutch 62 rotatably coupled to the input shaft 24, the planetary gearset 38, and the primary output shaft 30. In this embodiment, the clutch 62 is further defined as the dual clutch 70.

In this embodiment, having the clutch 62 further defined as the dual clutch 70 allows the transfer case 10 to utilize two gear ratios (high and low driving modes described above), which increases performance and drive capabilities of the vehicle 12 when using the electric machine 48 to propel the vehicle 12.

In the embodiment of FIG. 4, although not expressly shown, it is to be appreciated that when the clutch 62 is further defined as a dual clutch 70, the input member 54 may be rotatably coupled to the primary output shaft 30. In other words, rather than rotatably coupling the electric machine 48 to the input shaft 24 through the input member 54, the electric machine 48 may be rotatably coupled to the primary output shaft 30 through the input member 54 such that the electric machine 48 is providing rotational torque to the primary output shaft 30 after the planetary gearset 38. Such an arrangement of the electric machine 48 being rotatably coupled to the primary output shaft 30 through the input member 54 is disclosed in U.S. Pat. No. 10,688,866, which was filed on Aug. 22, 2017 and issued on Jun. 23, 2020, the disclosure of which is incorporated by reference in its entirety.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A transfer case for use in a vehicle, with the vehicle comprising a powertrain for providing rotational torque to at least one of a first and second set of wheels of the vehicle, said transfer case comprising:
an input shaft configured to be rotatably coupled to the powertrain;
a primary output shaft rotatably coupled to said input shaft to provide rotational torque to the first set of wheels of the vehicle;
a secondary output shaft selectively rotatably coupled to said primary output shaft to provide rotational torque to the second set of wheels of the vehicle;
a planetary gearset disposed between and rotatably coupled to said input shaft and said primary output shaft;
an input member; and
an electric machine;
wherein said input member is rotatably coupled to said electric machine and said input shaft to provide rotational torque from said electric machine, to said input shaft, and to said primary output shaft.

2. The transfer case as set forth in claim 1, further comprising a clutch rotatably coupled to said input shaft, said planetary gearset, and said primary output shaft.

3. The transfer case as set forth in claim 2, wherein said clutch is further defined as a dual clutch.

4. The transfer case as set forth in claim 2, wherein said clutch is further defined as a selectable one-way clutch and a wet clutch.

5. The transfer case as set forth in claim 1, wherein said primary output shaft is further defined as a rear-wheel output shaft, wherein the first set of wheels of the vehicle are rear wheels, wherein said secondary output shaft is further defined as a front-wheel output shaft, and wherein said second set of wheels of the vehicle are front wheels.

6. The transfer case as set forth in claim 1, further comprising a second planetary gearset rotatably coupled to said electric machine and said input member.

7. The transfer case as set forth in claim 1, further comprising a disconnect clutch coupled to said input shaft and said input member for selectively rotatably coupling said electric machine to said input shaft.

8. The transfer case as set forth in claim 1, further comprising a transfer case input member rotatably coupled to said secondary output shaft and said primary output shaft for rotatably coupling said secondary output shaft and said primary output shaft to provide rotational torque to both the first and second set of wheels of the vehicle.

9. The transfer case as set forth in claim 8, further comprising a mode clutch coupled to said primary output shaft to selectively rotatably couple said primary output shaft and said secondary output shaft through said transfer case input member to provide rotational torque to both the first and second set of wheels.

10. The transfer case as set forth in claim 9, further comprising a mode clutch actuator to actuate said mode clutch between a mode engaged position where said primary output shaft and said secondary output shaft are rotatably coupled to one another though said transfer case input member to provide rotational torque to both the first and second set of wheels, and a mode disengaged position where said primary output shaft and said secondary output shaft are rotatably decoupled from one another such that said input shaft provides rotational torque to only said primary output shaft output shaft.

11. The transfer case as set forth in claim 1, wherein said electric machine and said secondary output shaft are concentric.

12. The transfer case as set forth in claim 1, further comprising a battery, and a controller for controlling operation of the powertrain and said electric machine in,
a first mode of operation, wherein only the powertrain provides rotational torque to at least one of the first and second sets of wheels of the vehicle,
a second mode of operation, wherein only said electric machine provides rotational torque to at least one of the first and second sets of wheels of the vehicle,
a third mode of operation, wherein both the powertrain and said electric machine provide rotational torque to at least one of the first and second wheels of the vehicle, and
a fourth mode of operation, wherein said battery is recharged.

13. A transfer case for use in a vehicle, with the vehicle comprising a powertrain for providing rotational torque to a first and second set of wheels of the vehicle, said transfer case comprising:
an input shaft configured to be rotatably coupled to the powertrain;
a primary output shaft rotatably coupled to said input shaft to provide rotational torque to the first set of wheels of the vehicle;
a secondary output shaft selectively rotatably coupled to said primary output shaft to provide rotational torque to the second set of wheels of the vehicle;
a planetary gearset disposed between and rotatably coupled to said input shaft and said primary output shaft.
an input member configured to provide rotational torque to said primary output shaft;
an electric machine rotatably coupled to said input member; and
a clutch rotatably coupled to said input shaft, said planetary gearset, and said primary output shaft;
wherein said clutch is further defined as a dual clutch.

14. The transfer case as set forth in claim 13, wherein said primary output shaft is further defined as a rear-wheel output shaft, wherein the first set of wheels of the vehicle are rear wheels, wherein said secondary output shaft is further defined as a front-wheel output shaft, and wherein said second set of wheels of the vehicle are front wheels.

15. The transfer case as set forth in claim 13, further comprising a transfer case input member rotatably coupled to said secondary output shaft and said primary output shaft for rotatably coupling said secondary output shaft and said primary output shaft to provide rotational torque to both the first and second set of wheels of the vehicle.

16. The transfer case as set forth in claim 15, further comprising a mode clutch coupled to said primary output shaft to selectively rotatably couple said primary output shaft and said secondary output shaft through said transfer case input member to provide rotational torque to both the first and second set of wheels.

17. The transfer case as set forth in claim 16, further comprising a mode clutch actuator to actuate said mode clutch between a mode engaged position where said primary output shaft and said secondary output shaft are rotatably coupled one another though said transfer case input member to provide rotational torque to both the first and second set of wheels, and a mode disengaged position where said primary output shaft and said secondary output shaft are rotatably decoupled from one another such that said input shaft provides rotational torque to only said primary output shaft.

18. The transfer case as set forth in claim 13, wherein said electric machine and said secondary output shaft are concentric.

19. The transfer case as set forth in claim 13, wherein said input member is rotatably coupled to said primary output shaft.

20. The transfer case as set forth in claim 13, further comprising a battery, and a controller for controlling operation of the powertrain and said electric machine in,
a first mode of operation, wherein only the powertrain provides rotational torque to at least one of the first and second sets of wheels of the vehicle,
a second mode of operation, wherein only said electric machine provides rotational torque to at least one of the first and second sets of wheels of the vehicle,
a third mode of operation, wherein both the powertrain and said electric machine provide rotational torque to at least one of the first and second sets of wheels of the vehicle, and
a fourth mode of operation, wherein said battery is recharged.
